(19) United States
(12) Patent Application Publication
(10) Pub. No.: US 2025/0091374 A1
(43) Pub. Date: Mar. 20, 2025

(54) PRINTING DEVICE AND CONTROL METHOD FOR PRINTING DEVICE

(71) Applicant: Toshiba Tec Kabushiki Kaisha, Tokyo (JP)

(72) Inventors: Masakazu KATO, Numazu Shizuoka (JP); Sadatoshi OISHI, Fuji Shizuoka (JP)

(73) Assignee: Toshiba Tec Kabushiki Kaisha, Tokyo (JP)

(21) Appl. No.: 18/669,186

(22) Filed: May 20, 2024

(30) Foreign Application Priority Data
Sep. 15, 2023 (JP) 2023-150443

(51) Int. Cl. B41J 33/00; B41J 2/325; B41J 33/06

(52) U.S. Cl. CPC B41J 33/003; B41J 2/325; B41J 33/06

(57) ABSTRACT

According to at least one embodiment, a printing device includes a shaft, an antenna, a drive unit, and a control unit. The shaft is inserted into a cylindrical body of a medium roll in which a medium is wound around the cylindrical body equipped with a wireless tag, and rotatably supports the cylindrical body. The antenna is provided on the shaft to perform data communication with the wireless tag. The drive unit rotates the cylindrical body equipped with the wireless tag around the shaft. The control unit controls the drive unit so that the cylindrical body equipped with the wireless tag rotates around the shaft by a predetermined angle.

### CROSS-REFERENCE TO RELATED APPLICATION

This application is based upon and claims the benefit of priority from Japanese Patent Application No. 2023-150443, filed on Sep. 15, 2023, the entire contents of which are incorporated herein by reference.

### FIELD

Embodiments described herein relate generally to a printing device using an ink ribbon and a control method for the printing device.

### BACKGROUND

For example, a label printer conveys an ink ribbon on a long label paper, transfers the ink from the ink ribbon to the label paper using a thermal head, and prints various types of information such as barcodes on each label on the label paper.

The label printer changes a printing speed depending on the type of used ink ribbon. In the related art, there is a technology to provide a wireless tag on the ribbon roll wound with the ink ribbon, and to communicate data between the printer body and the wireless tag. By using such technology, the printing speed of the printer body can be automatically set to a speed that matches the ink ribbon of the ribbon roll newly mounted in the printer body.

The printer body includes an antenna to communicate data with the wireless tag of the ribbon roll. To provide good data communication with the wireless tag, the antenna on the printer body side must be disposed closer to the wireless tag of the ribbon roll.

The diameter of the ribbon roll becomes smaller as the ink ribbon is used. From a different perspective, when automatically setting the printing speed (when starting to use the ribbon roll), the diameter of the ribbon roll is maximum. Therefore, for example, when the wireless tag is provided on a core material of the ribbon roll, the distance between the wireless tag and the antenna becomes large, which makes good data communication difficult.

The same can be said not only for ribbon rolls, but also for label paper rolls in which a long strip of label paper is wound in a roll shape.

### DESCRIPTION OF THE DRAWINGS

FIG. 1 is an outline diagram showing a label printer according to a first embodiment;

FIG. 2 is a partially enlarged perspective view showing main parts of a delivery shaft;

FIG. 3 is an exploded perspective view of the delivery shaft;

FIG. 4 is a sectional view of the main parts of the delivery shaft;

FIG. 5 is a perspective view showing a ribbon roll paper tube attached to the delivery shaft;

FIG. 6 is a block diagram showing an example of a control system of the label printer;

FIG. 7 is a diagram showing an example of an IC tag;

FIG. 8 is a diagram showing an example of success or failure results of data reading depending on angles with respect to an antenna when the IC tags are attached to the paper tube;

FIG. 9 is a schematic diagram showing a state in which the angle of the IC tag with respect to the antenna is 0 degrees;

FIG. 10 is a schematic diagram showing a state in which the angle of the IC tag with respect to the antenna is 90 degrees;

FIG. 11 is a flowchart showing an example of an IC tag reading process by a control unit;

FIG. 12 is a diagram showing an example of the placement of a photo sensor for measuring a diameter of an ink ribbon;

FIG. 13 is a diagram an example of memory contents in a ribbon information memory configured in a memory of a label printer according to a second embodiment;

FIG. 14 is a flowchart showing an example of an IC tag reading process by a control unit of the label printer;

FIG. 15 is a flowchart showing an example of an IC tag reading process by a control unit of a label printer according to a third embodiment; and

FIG. 16 is a flowchart showing an example of an IC tag reading process by a control unit of a label printer according to a modification example of the third embodiment.

### DETAILED DESCRIPTION

According to at least one embodiment, there is provided a printing device that can provide good data communication with media rolls such as ribbon rolls and label paper rolls, and a control method for the printing device.

In general, according to one embodiment, a printing device includes a shaft, an antenna, a drive unit (driver), and a control unit (controller). The shaft is inserted into a cylindrical body of a medium roll in which a medium is wound around the cylindrical body equipped with a wireless tag, and rotatably supports the cylindrical body. The antenna is provided on the shaft to perform data communication with the wireless tag. The drive unit rotates the cylindrical body equipped with the wireless tag around the shaft. The control unit controls the drive unit so that the cylindrical body equipped with the wireless tag rotates around the shaft by a predetermined angle.

Hereinafter, respective embodiments will be described with reference to the drawings. In the drawings used for the description below, there are cases where the scale of each part is appropriately changed. The drawing may be shown by simplifying or omitting the configuration to make the explanation easier to understand.

### First Embodiment

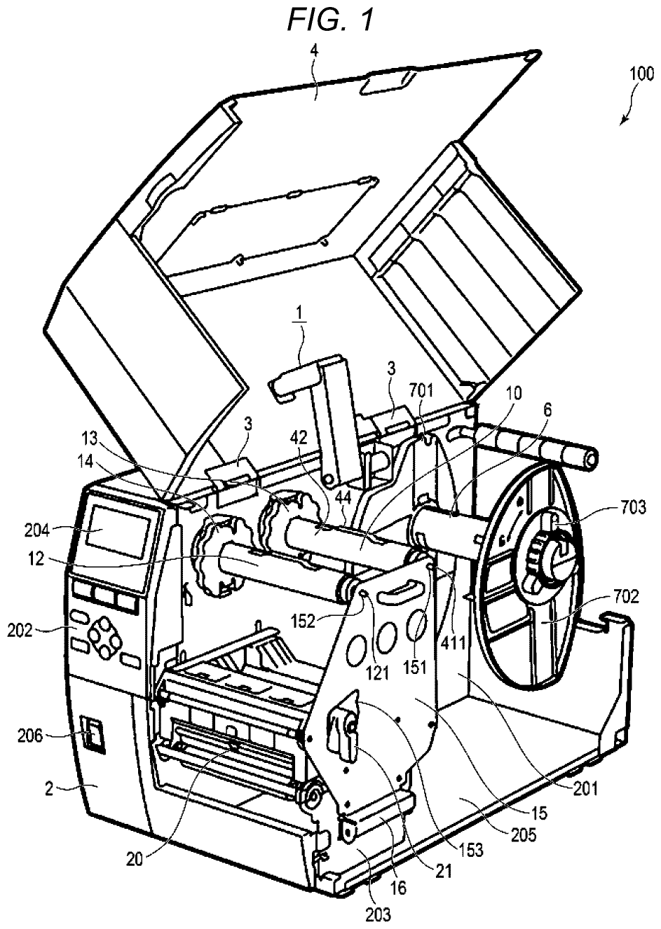

A label printer 100 according to a first embodiment will be described with reference to FIGS. 1 to 12. The label printer 100 is an example of the printing device described in the claims of the present application.

FIG. 1 is an outline diagram showing the label printer 100 according to the first embodiment. As shown in FIG. 1, the label printer 100 includes a housing 2 and a cover 4. The cover 4 is rotatably connected to the housing 2 via two hinges 3. The cover 4 can be rotated between an opening position shown in FIG. 1, in which the inside of the housing 2 is opened, and a close position in which the inside of the housing 2 is covered. There is a damper 1 for easing opening and closing operations of the cover 4 between the cover 4 and the housing 2. With the cover 4 closed, the label printer 100 has an approximately rectangular block-shaped appearance.

On the front of the housing 2, there are an operation unit 202, a display unit 204, and a power switch 206. The operation unit 202 inputs information about label paper, the number of prints, and the like. The display unit 204 displays operation information, operation menus, or the like.

The label printer 100 includes a supply shaft 6 for attaching a label paper roll, a delivery shaft 10 for detachably attaching a ribbon roll in which an ink ribbon before use is wound around a paper tube 30 (FIG. 5), a take-up shaft 12 for detachably attaching a ribbon roll in which a used ink ribbon is wound, and a printing unit 20 (printer). The printing unit 20 is an example of the printing unit described in the claims of the present application.

The label paper roll is a roll in which a long strip of label paper is wound in a roll shape. The label paper has a plurality of labels adhered to one side of a long mount. The label has an adhesive layer on the surface of the mount side, can be attached to the mount, and can be peeled off from the mount and adhered on other items. The label paper roll is made by wounding label paper around a core material with the label-adhered side of the mount facing inward. Label paper is an example of the printing paper described in the claims of the present application. The printing paper is not limited to label paper, but may be a strip of thermal paper.

A long ink ribbon is wound in a roll shape in the ribbon roll. The ink ribbon stores ink that is thermally transferred to label paper. In the ribbon roll before use, the ink ribbon before transferring the ink is wound around the paper tube 30, and the diameter becomes small with use. In the used ribbon roll, the ink ribbon after transferring the ink is wound, and the diameter gradually increases. In other words, the ink ribbon pulled out from the ribbon roll before use is wound up on the downstream side of the printing unit 20 to form the used ribbon roll. The ribbon roll before use is an example of the medium roll and the ribbon roll described in the claims of the present application. The paper tube 30 is an example of the cylindrical body described in the claims of the present application.

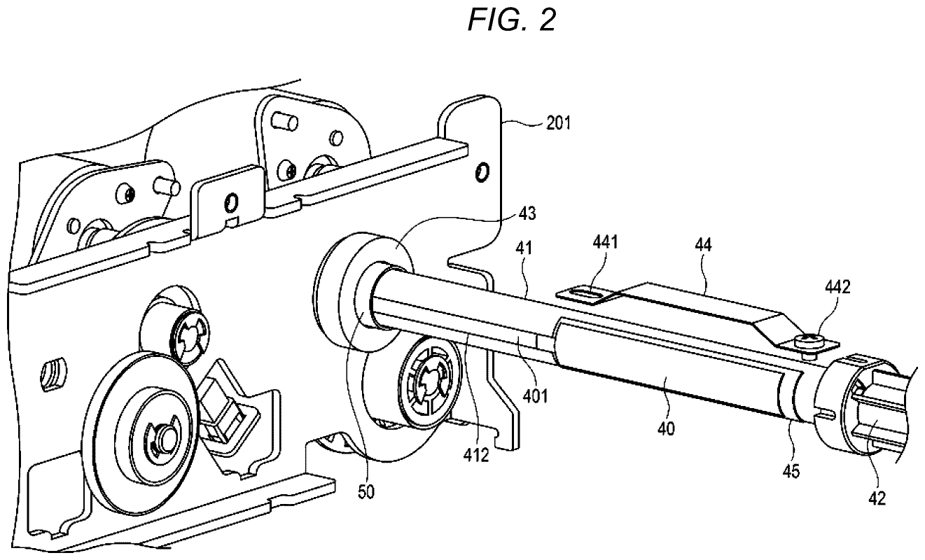

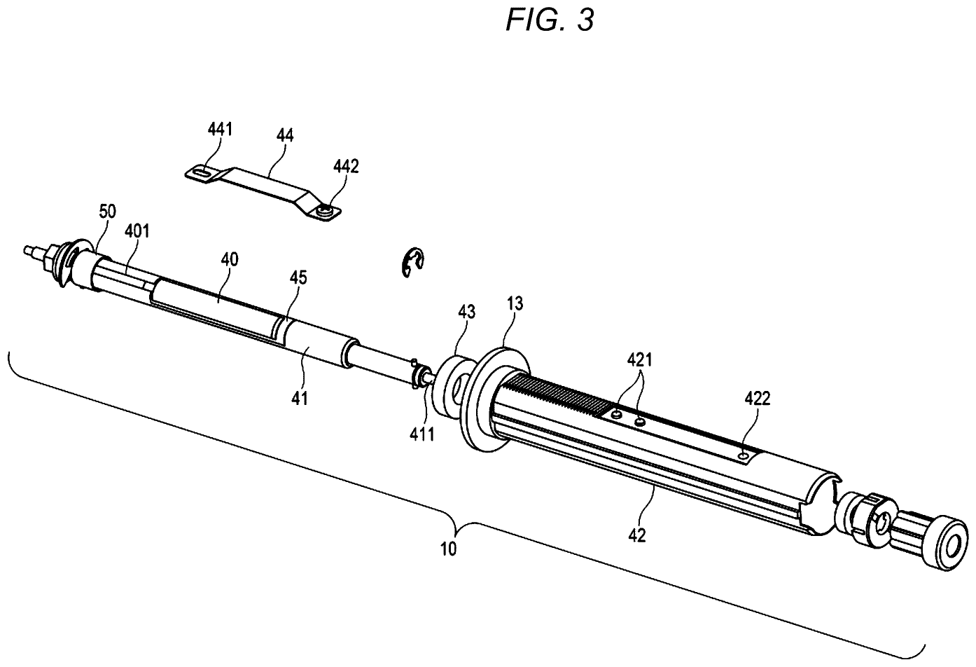

A side wall 201 of the housing 2 fixes one ends of the supply shaft 6, the delivery shaft 10, and the take-up shaft 12. In other words, the side wall 201 holds three shafts 6, 10, and 12 in a cantilever state. The take-up shaft 12 has substantially the same structure as the delivery shaft 10, except that the take-up shaft 12 does not include an antenna 40 (FIGS. 2 and 3), which will be described later. Therefore, in the following explanation, the detailed explanation of the take-up shaft 12 is omitted.

The supply shaft 6 includes two hold plates 701 and 702 which are in contact with both axial end surfaces of the label paper roll, near both longitudinal ends. The hold plate 701 on the back side near the side wall 201 can be moved along the longitudinal direction of the supply shaft 6. The hold plate 701 determines an attaching position of the label paper roll in the axial direction such that an axial center of the label paper roll is adjusted to a center of the label printer 100. The hold plate 702 on the front side, which is attached near the end of the supply shaft 6 on the side away from the side wall 201 of the housing 2, is fixed to the supply shaft 6 with a fixture 703.

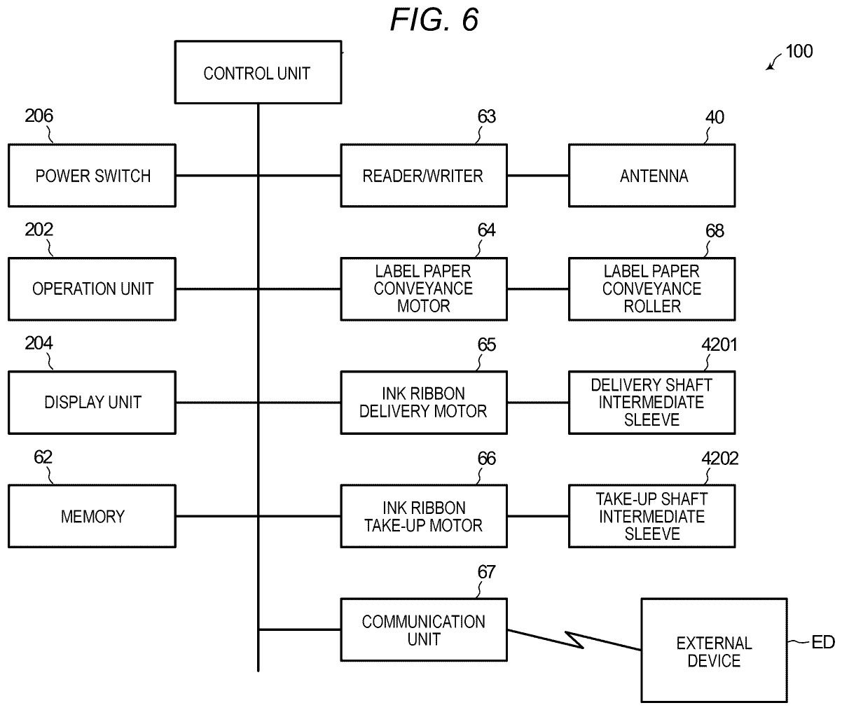

When attaching the label paper roll to the supply shaft 6, the label paper roll is attached to the supply shaft 6 with the hold plate 702 on the front side removed from the supply shaft 6. Then, the hold plate 702 on the front side is attached to the front end of the supply shaft 6. The label paper in the label paper roll is pulled from the label paper roll by a label paper conveyance roller 68 (FIG. 6) and comes out of the label printer 100 through the printing unit 20.

The delivery shaft 10 and the take-up shaft 12 of the ribbon roll include stopper plates 13 and 14 near the side wall 201 of the housing 2, respectively. The stopper plates 13 and 14 can be moved along the longitudinal direction of the shafts 10 and 12. The stopper plate 13 abuts one axial end of the ribbon roll before use attached to the delivery shaft 10 to align the axial center of the ribbon roll before use with the center of the label printer 100. The stopper plate 14 abuts one axial end of the used ribbon roll attached to the take-up shaft 12 to align the axial center of the used ribbon roll with the center of the label printer 100.

A ribbon shaft fixing plate 15 is provided at a position facing front ends of the delivery shaft 10 and the take-up shaft 12 on the side away from the side wall 201. The ribbon shaft fixing plate 15 is rotatably connected to a support plate 203 standing upward from a bottom wall 205 of the housing 2 via a hinge 16. The ribbon shaft fixing plate 15 includes a receiving hole 151 for receiving a tip 411 of a fixed shaft 41 (described later) of the delivery shaft 10 (hereinafter, sometimes simply referred to as the tip 411 of the delivery shaft 10), and a receiving hole 152 for receiving a tip 121 of the take-up shaft 12. The ribbon shaft fixing plate 15 includes an insertion hole 153 into which a head lever 21 of the printing unit 20 is inserted.

When attaching the ribbon roll to the delivery shaft 10, the ribbon shaft fixing plate 15 is opened in a position (not shown) and the ribbon roll is attached to the delivery shaft 10. Thereafter, the ribbon shaft fixing plate 15 is rotated to the illustrated position, the tip 411 of the delivery shaft 10 is inserted into the receiving hole 151, and the tip 121 of the take-up shaft 12 is inserted into the receiving hole 152. Here, the ribbon shaft fixing plate 15 fixes the tip 411 of the delivery shaft 10 and the tip 121 of the take-up shaft 12.

The ink ribbon pulled out from the ribbon roll attached to the delivery shaft 10 passes through the printing unit 20 (printer) and is wound by the take-up shaft 12. The printing unit 20 conveys the ink ribbon superimposed on top of the label paper, and causes the ink ribbon to pass through the printing unit 20 at the same speed as the label paper.

The printing unit 20 includes a thermal head disposed on the side of the ink ribbon opposite to the label paper. The printing unit 20 includes a platen roller at a position facing the thermal head with the ink ribbon and the label paper interposed therebetween. The printing unit 20 presses the ink ribbon against the label paper using the thermal head, and thermally transfers the ink on the ink ribbon to the label paper. The printing unit 20 prints a two-dimensional barcode or the like on the label of label paper.

FIG. 2 is a partially enlarged perspective view showing main parts of the delivery shaft 10 of the label printer 100. FIG. 3 is an exploded perspective view of the delivery shaft 10. As shown in FIGS. 2 and 3, the delivery shaft 10 includes the fixed shaft 41 fixed to the side wall 201 of the housing 2 in a cantilever state, an intermediate sleeve 42 coaxially arranged outside the fixed shaft 41, and a bearing 43 coaxially arranged outside the fixed shaft 41. The fixed shaft 41 is an example of the shaft described in the claims of the present application.

The fixed shaft 41 is, for example, a solid metal shaft, and is fixed to the side wall 201 of the housing 2 in a cantilever state using bolts. The tip 411 of the fixed shaft 41 protrudes from the front end of the intermediate sleeve 42.

The intermediate 42 sleeve has a substantially cylindrical shape, and includes the bearing 43 therein near the end on the side wall 201 side. The bearing 43 is fitted inside the end of the intermediate sleeve 42 and fixed to the intermediate sleeve 42. The bearing 43 is cylindrical and can be made of resin or metal. The inner diameter of the intermediate sleeve 42 is approximately the same as the outer diameter of the bearing 43.

The intermediate sleeve 42 is rotatable with respect to the fixed shaft 41 by the bearing 43. The intermediate sleeve 42 includes the above-described stopper plate 13 on the outside near the end on the side wall 201 side. The stopper plate 13 can be moved in the longitudinal direction of the intermediate sleeve 42 and can be fixed at a desired position in the longitudinal direction.

The outer peripheral surface of the intermediate sleeve 42 includes two boss portions 421 for positioning a leaf spring 44 and a screw hole 422 for fastening and fixing the leaf spring 44 to the outer peripheral surface of the intermediate sleeve 42. The leaf spring 44 includes a slit 441 at one end on the side wall 201 side into which the boss portions 421 are inserted, and a screw hole through which a screw 442 is inserted at the other end. The leaf spring 44 is fixed to the outer peripheral surface of the intermediate sleeve 42 by inserting the boss portions 421 of the intermediate sleeve 42 into the slit 441 and screwing the screw 442 into the screw hole 422.

The leaf spring 44 is made of metal, and with the paper tube 30 of the ribbon roll attached to the outside of the intermediate sleeve 42, the leaf spring 44 presses the inner surface of the paper tube 30 is pushed outward to fix the paper tube 30 to the intermediate sleeve 42. The leaf spring 44 protrudes from the outer peripheral surface of the intermediate sleeve 42 to an extent that the intermediate sleeve 42 can be inserted into the paper tube 30. The leaf spring 44 has a width in the circumferential direction that is narrower than the width of the antenna 40 along the circumferential direction of the fixed shaft 41.

A sheet-shaped antenna 40 is provided on the outer peripheral surface of the fixed shaft 41. On the outer peripheral surface of the fixed shaft 41, a wiring 401 is provided that is electrically connected to the antenna 40 and extends in the longitudinal direction of the fixed shaft 41. The antenna 40 and the wiring 401 are, for example, continuous metal foil, or may be formed by patterning metal foil on the surface of a flexible substrate. For example, the pattern of the antenna 40 is in the shape of a loop antenna to form a magnetic field.

A magnetic sheet 45 is provided between the outer peripheral surface of the fixed shaft 41 and the antenna 40. The magnetic sheet 45 is provided such that eddy current is generated in the metal fixed shaft 41 by the magnetic field formed by the antenna 40 and do not cancel out the magnetic field formed by the antenna 40. Therefore, the magnetic sheet 45 has a size slightly larger than the antenna 40 to be placed between the antenna 40 and the fixed shaft 41.

Since the antenna 40 is separated from the outer peripheral surface of the fixed shaft 41 by the thickness of the magnetic sheet 45, the end of the wiring 401 on the antenna 40 side is slightly inclined in the direction away from the outer peripheral surface of the fixed shaft 41 toward the antenna 40. Since the bearing 43 is provided between the intermediate sleeve 42 and the fixed shaft 41, the inner diameter of the intermediate sleeve 42 is sufficiently larger than the outer diameter of the fixed shaft 41. Therefore, when the fixed shaft 41 is inserted into the intermediate sleeve 42 or when the intermediate sleeve 42 rotates with respect to the fixed shaft 41, the inner surface of the intermediate sleeve 42 does not come into sliding contact with the antenna 40 and the wiring 401.

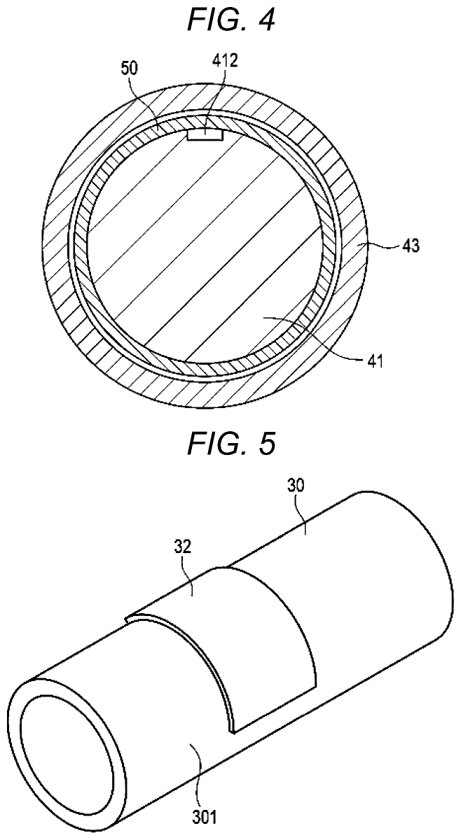

FIG. 4 is a sectional view of main parts of the delivery shaft 10. As shown in FIGS. 2 and 4, the fixed shaft 41 has a groove-shaped recess 412 provided on the outer peripheral surface thereof along the longitudinal direction. The width of the recess 412 along the circumferential direction of the fixed shaft 41 is slightly wider than the width of the wiring 401. The depth of the recess 412 is slightly deeper than the thickness of the wiring 401. After the magnetic sheet 45 is adhered to the outer circumferential surface of the fixed shaft 41, the antenna 40 is adhered to overlap the magnetic sheet 45.

A protective sleeve 50 is located near the end of the fixed shaft 41 on the side wall 201 side. The protective sleeve 50 has an inner diameter that is approximately the same as the outer diameter of the fixed shaft 41 and an outer diameter that is slightly smaller than the inner diameter of the bearing 43. That is, there is a gap equal to the thickness of the protective sleeve 50 between the intermediate sleeve 42 and the fixed shaft 41. The protective sleeve 50 is interposed between the wiring 401 and the bearing 43, and is fitted onto and fixed to the end of the fixed shaft 41.

When the fixed shaft 41 to which the protective sleeve 50 is fixed is inserted into the intermediate sleeve 42 with the bearing 43 fitted to one end, and the intermediate sleeve 42 is attached to the fixed shaft 41, the inner peripheral surface of the bearing 43 comes into contact with the outer peripheral surface of the protective sleeve 50. Since the inner diameter of the bearing 43 is slightly larger than the outer diameter of the protective sleeve 50 and there is a slight gap between the bearing 43 and the protective sleeve 50, the intermediate sleeve 42 with the bearing 43 can rotate relative to the fixed shaft 41 with the protective sleeve 50. The protective sleeve 50 prevents sliding contact between the intermediate sleeve 42 and the wiring 401 housed in the recess 412 of the fixed shaft 41 when the intermediate sleeve 42 rotates with respect to the fixed shaft 41.

FIG. 5 is a perspective view showing the paper tube 30 of the ribbon roll attached to the delivery shaft 10. As shown in FIG. 5, the paper tube 30 of the ribbon roll includes an IC tag 32 that communicates wirelessly. The IC tag 32 has, for example, the shape of a rectangular sheet, and is adhered to an outer circumferential surface 301 of the paper tube 30 approximately at the axial center of the paper tube 30. The ink ribbon is wound around the outer peripheral surface of the paper tube 30 to overlap the outside of the IC tag 32. As long as the IC tag 32 is provided on the paper tube 30, the IC tag 32 may be provided on the inner surface of the paper tube 30, or at an intermediate portion between the outer peripheral surface and the inner surface of the paper tube 30. The IC tag is an example of the wireless tag described in the claims of the present application.

FIG. 6 is a block diagram showing an example of a control system of the label printer 100. As shown in FIG. 6, the label printer 100 includes a control unit 60 that sets the printing speed according to the type of ink ribbon. The control unit (controller) 60 is configured by, for example, a processor such as a central processing unit (CPU). Examples of the processor include a micro processing unit (MPU), a system on a chip (SoC), a digital signal processor (DSP), a graphics processing unit (GPU), an application specific integrated circuit (ASIC), a programmable logic device (PLD), a field-programmable gate array (FPGA), or the like. Alternatively, the processor may be a combination of a plurality of components. The control unit 60 is an example of the control unit described in the claims of the present application.

The control unit 60 connects a power switch 206, an operation unit 202, a display unit 204, a memory 62, a reader/writer 63, a label paper conveyance motor 64, an ink ribbon delivery motor 65, an ink ribbon take-up motor 66, and a communication unit 67.

The memory 62 stores a control program and also stores data regarding printing speeds suitable for the types of ink ribbons. The reader/writer 63 wirelessly communicates with the IC tag 32 via the antenna 40, writes data to the IC tag 32, and reads data from the IC tag 32. The reader/writer 63 is an example of the data communication unit described in the claims of the present application. The label paper conveyance motor 64 rotates the label paper conveyance roller 68 that pulls the label paper from the label paper roll. The ink ribbon delivery motor 65 rotates the intermediate sleeve 42 of the delivery shaft 10 (hereinafter sometimes referred to as delivery shaft intermediate sleeve 4201). The ink ribbon take-up motor 66 rotates the intermediate sleeve 42 of the take-up shaft 12 (hereinafter sometimes referred to as the take-up shaft intermediate sleeve 4202). The ink ribbon delivery motor 65 and the delivery shaft intermediate sleeve 4201, and the ink ribbon take-up motor 66 and the take-up shaft intermediate sleeve 4202 are examples of the drive unit described in the claims of the present application. The communication unit 67 transmits and receives various types of data to and from an external device ED such as a host computer.

When the power switch 206 is turned on, the control unit 60 controls the reader/writer 63 to read data from the IC tag 32 via the antenna 40. In particular, when replacing the ribbon roll of the delivery shaft 10, the label printer 100 is designed such that the cover 4 of the housing 2 can be opened and the ribbon roll can be replaced only after the power switch 206 has been turned off once, or it is recommended to once turn off the power switch 206 and then replace the ribbon roll. Therefore, in many cases, when using the label printer 100 after replacing the ribbon roll on the delivery shaft 10, the power switch 206 will be turned on, and data will be read from the IC tag 32. Alternatively, the number of openings and closings of the cover 4 is stored in the memory 62 in a non-volatile manner, and an opening and closing counter which mechanically counts the number of openings and closings of the cover 4 and of which count value can be read by the control unit 60 is provided, so that when the power switch 206 is turned on, and the count value of the opening and closing counter is different from the number of openings and closings stored in the memory 62, the control unit 60 may read data from the IC tag 32.

The IC tag 32 stores data regarding the ink ribbon wound around the paper tube 30. The data regarding the ink ribbon includes, for example, product name, type (for plain paper, for thick material), width, length, date of manufacture, serial number (manufacturing number), remaining amount of the ink ribbon, and the like.

Thereafter, the control unit 60 reads, from the memory 62, a printing speed that matches the type of ink ribbon read from the IC tag 32, and controls the label paper conveyance motor 64, the ink ribbon delivery motor 65, and the ink ribbon take-up motor 66 to operate at the read printing speed. The control unit 60 controls the label paper conveyance motor 64, the ink ribbon delivery motor 65, and the ink ribbon take-up motor 66 to print at the read printing speed until the ink ribbon is completely used.

The control unit 60 rewrites the remaining amount of the ink ribbon recorded in the memory 62 at the timing when each print task ends. The control unit 60 can display the remaining amount of the ink ribbon via the display unit 204.

As described above, in the label printer 100 according to the present embodiment, since the antenna 40 is provided on the delivery shaft 10 mounted with the ribbon roll in which the ink ribbon is wound around the paper tube 30, the antenna 40 can be disposed close to the IC tag 32 adhered to the paper tube 30, and good data communication with the IC tag 32 is possible.

Incidentally, the direction of the paper tube 30 when attaching the ribbon roll to the delivery shaft 10 is set by the user. Therefore, the circumferential position of the IC tag 32 when the ribbon roll is attached to the delivery shaft 10 is not specified. That is, the IC tag 32 may be attached to the antenna 40 to directly face the antenna 40, or may be attached in the opposite direction.

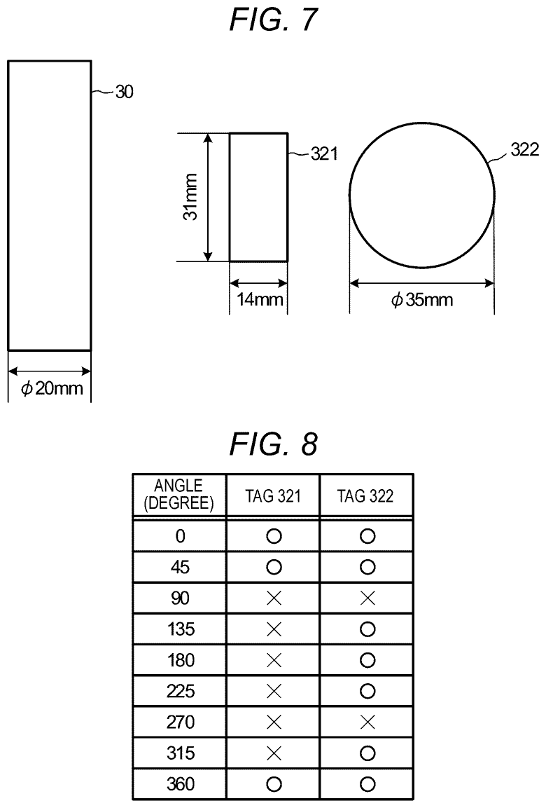

The diameter and length of the paper tube 30 of the ribbon roll are specified by the shape and size of the delivery shaft 10 of the label printer 100, and are therefore limited to some extent, but there are no restrictions on the shape or size of the IC tag 32 that is adhered to the outer peripheral surface 301 of the paper tube 30. The shape and size of the IC tag 32 to be adopted is set freely by the discretion of the manufacturer of the ribbon roll. FIG. 7 is a diagram showing an example of the IC tag 32. The paper tube 30 is disposed side by side with the IC tag 32 for reference. As shown in FIG. 7, one manufacturer uses a rectangular sheet-like IC tag 321 of 31×14 mm, and another manufacturer uses a circular sheet-like IC tag 322 with a diameter of φ35 mm.

Therefore, there are various combinations of the shape and size of the IC tag 32 and the positional relationship between the antenna 40 and the IC tag 32 when the ribbon roll is attached to the delivery shaft 10. Depending on the combination, the reader/writer 63 may not be able to read data from the IC tag 32 via the antenna 40.

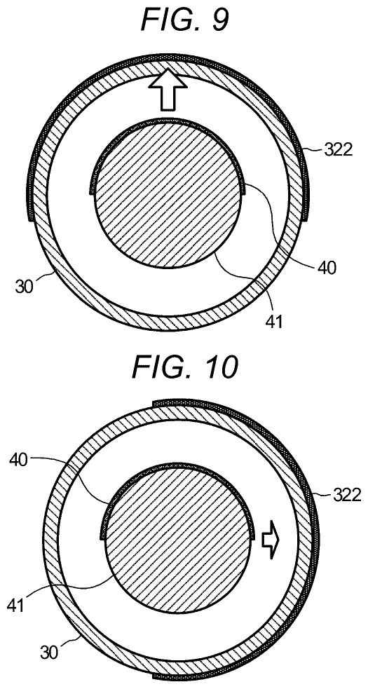

FIG. 8 is a diagram showing an example of success or failure results of data reading depending on the angles of the IC tags 321 and 322 of FIG. 7 attached to the paper tube 30 with respect to the antenna 40. In FIG. 8, a circle mark indicates data reading success, and a cross mark indicates data reading failure. FIG. 9 is a schematic diagram showing a state in which the angle of the IC tag 32 with respect to the antenna 40 is 0 degrees, and FIG. 10 is a schematic diagram showing a state in which the angle is 90 degrees. In FIGS. 9 and 10, white arrows indicate the main direction and magnitude of the magnetic field that the IC tag 32 receives.

For example, the radial width of the antenna 40 of the fixed shaft 41 is half of the fixed shaft 41 in the radial direction as shown in FIGS. 9 and 10, that is, the antenna 40 covers half of the fixed shaft 41 in the radial direction. Here, the magnetic field generated by the antenna 40 is strong at the center of the antenna 40 and weak at the ends, as shown in FIG. 9.

With respect to the IC tag 322 having a maximum width that is equal to or more than half of the paper tube 30 in the radial direction, as shown in FIG. 9, when the IC tag 322 is located at a 0 degree angle to the antenna 40, that is, when the center point of the radial width of the IC tag 322 coincides with the center point of the radial width of the antenna 40, data reading is successful because the IC tag 322 receives a strong magnetic field generated by the antenna 40. On the other hand, as shown in FIG. 10, when the IC tag 322 is located at a 90 degree angle to the antenna 40, that is, when the antenna 40 and the IC tag 322 are in a perpendicular positional relationship, data reading fails because the IC tag 322 is difficult to receive the magnetic field generated by the antenna 40. The same applies to the positional relationship of 270 degrees, which is the −90 degree position. Because data reading is successful in the direction of 180 degrees (back side of the antenna 40), the magnetic field in the direction of 180 degrees is estimated to be stronger than the magnetic field in the direction of ±90 degrees.

Since the basic operation is electromagnetic induction, unless the magnetic field generated by the antenna 40 penetrates the loop antenna of the IC tag 322, no electromotive force will be generated in the IC tag 322 and communication will not be possible. The situation where communication is not possible is when the IC tag 322 is in a positional relationship with the antenna 40 of ±90 degrees.

In the case of the IC tag 321 of which width is only small relative to the radial dimension of the paper tube 30, the range of angles at which data communication fails is wider than that of the IC tag 322.

Note that the leaf spring 44 may be located between the IC tag 32 and the antenna 40. However, as shown in FIG. 8, the leaf spring 44 does not become a major impediment to communication. For example, unlike high-frequency wireless communication such as WiFi (registered trademark) that uses 2.4 GHz, the IC tag 32 and the antenna 40 communicate by, for example, a 13.56 MHz magnetic field. The leaf spring 44 does not pose a major obstacle that would interrupt communication.

For the label printer 100 according to the present embodiment to enable good data communication with the ribbon roll regardless of the shape and size of the IC tag 32, the control unit 60 performs the following operations. The contents of processes in the following operation description are an example, and various types of processing capable of achieving similar effects can be suitably used.

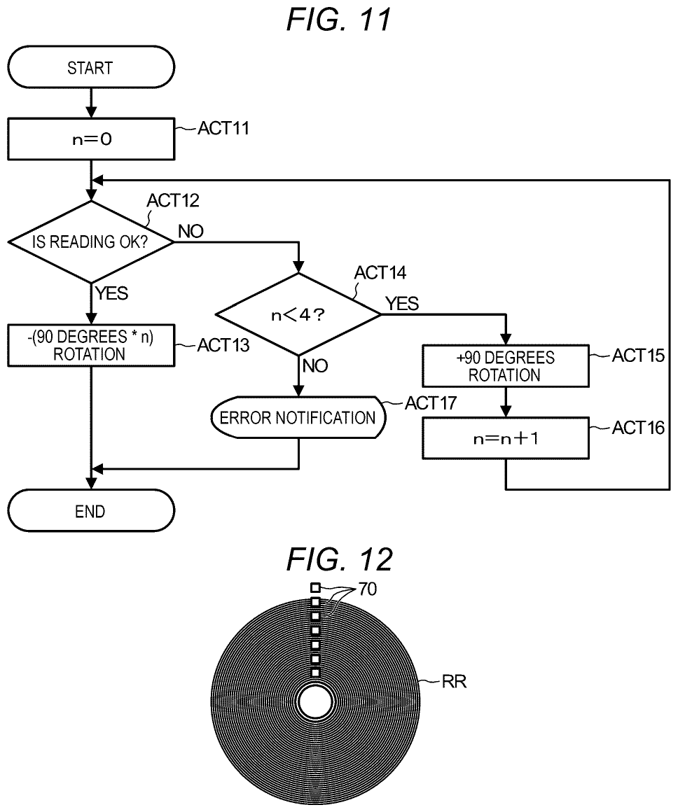

FIG. 11 is a flowchart showing an example of an IC tag reading process by the control unit 60. The control unit executes the process based on the control program stored in the memory 62. Note that, unless otherwise specified, it is assumed that the processing operation of the control unit 60 transitions from ACT x (x is a natural number) to ACT (x+1).

The control unit 60 of the label printer 100 starts the process shown in FIG. 11, for example, when the power switch 206 is turned on.

In ACT 11, the control unit 60 initializes the value of a counter n provided internally or configured in the memory 62 to “0”.

In ACT 12, the control unit 60 determines whether data reading is OK, that is, whether the reader/writer 63 reads data from the IC tag 32 attached to the paper tube 30 of the ink ribbon via the antenna 40. The determination can be rephrased as determining whether data communication with the IC tag 32 is successful. Note that data reading is performed in a stationary state in which the paper tube 30 is not rotating the ribbon roll around the fixed shaft 41 of the delivery shaft 10.

In response to the determination that data reading is OK (ACT 12, YES), the control unit 60 controls the ink ribbon delivery motor 65 to rotate the delivery shaft intermediate sleeve 4201 by −(90 degrees×n) in ACT 13. Here, the control unit 60 also controls the ink ribbon take-up motor 66 to rotate the take-up shaft intermediate sleeve 4202 by −(90 degrees×n). Thereby, smooth rewinding of the ink ribbon can be implemented, and the paper tube 30 can be rotated without stress. As such, the control unit 60 rotates the delivery shaft intermediate sleeve 4201 and the take-up shaft intermediate sleeve 4202 at an angle obtained by multiplying 90 degrees by the value of the counter n in the direction in which the ink ribbon is rewound (hereinafter, rotation in the direction is referred to as reverse rotation), which is the opposite direction to rotation in the direction in which the ink ribbon is fed out (hereinafter, rotation in the direction is referred to as forward rotation). That is, the paper tube 30 of the ink ribbon is reversely rotated by (n×90 degrees). Here, since the value of the counter n is “0”, the IC tag reading process shown in the flowchart ends without rotation.

In response to the determination that data reading is not OK (ACT 12, NO), the control unit 60 determines in ACT 14 whether the value of the counter n is less than “4”.

In response to the determination that the value of the counter n is less than “4” (ACT 14, YES), the control unit 60 controls the ink ribbon delivery motor 65 to rotate the delivery shaft intermediate sleeve 4201 by +90 degrees in ACT 15. Here, the control unit 60 also controls the ink ribbon take-up motor 66 to rotate the take-up shaft intermediate sleeve 4202 by +90 degrees. Thereby, the ink ribbon can be smoothly fed out, and the paper tube 30 can be rotated without stress. As such, the control unit 60 rotates the paper tube 30 of the ink ribbon forward by 90 degrees.

Methods for the control unit 60 to know the rotation angle of the paper tube 30 include, but are not limited to, the following methods, for example.

(1) The rotation angle of at least one of the delivery shaft intermediate sleeve 4201 and the take-up shaft intermediate sleeve 4202 is detected by a sensor such as an optical sensor.

(2) At least one of the ink ribbon delivery motor 65 or the ink ribbon take-up motor 66 is configured with a stepping motor, and the control unit 60 calculates the rotation angle of the paper tube 30 from the number of rotations.

(3) The control unit 60 calculates the rotation angle of the paper tube 30 from the conveyance amount (length) of the ink ribbon and the diameter of the ink ribbon. The conveyance amount for rotating the paper tube 30 by a certain angle, such as 90 degrees, varies depending on the remaining amount of the ink ribbon. Without being limited thereto, for example, a rotating body such as a roller that comes into contact with the ink ribbon may be provided in a conveyance path of the ink ribbon, and the control unit 60 may calculate the conveyance length of the ink ribbon from the number of rotations. The diameter of the ink ribbon is the current outer diameter of the remaining ink ribbon, and is not limited thereto, but can be detected by using several photosensors, for example. FIG. 12 is a diagram showing an example of the placement of a photo sensor for measuring the diameter of the ink ribbon. A plurality of reflective photosensors 70 are installed in a row at regular intervals on the side wall 201 of the label printer 100 to directly face a ribbon roll RR attached to the delivery shaft 10.

In ACT 16, the control unit 60 increments the value of the counter n by “+1”. Thereafter, the control unit 60 proceeds to the processing operation of ACT 12.

As such, the paper tube 30 is rotated by 90 degrees at a time until data reading is OK. As a result, when the data reading is OK (ACT 12, YES), it can be said that the control unit 60 reversely rotated the paper tube 30 (n×90 degrees) in ACT 13. Here, since the value of the counter n is the value updated in ACT 16, the paper tube 30 is reversely rotated according to the number of times the 90 degree rotation has been performed. As a result, the ink ribbon that has been fed out to read data from the IC tag 32 is rewound onto the ribbon roll RR, so that the ink ribbon is not wasted. In response to the end of the rewinding, the control unit 60 may take up the slack in the ink ribbon, by reversely rotating the ink ribbon delivery motor 65 and rotating the ink ribbon take-up motor 66 forward by minute angles, respectively.

When the paper tube 30 rotates once without data reading being OK, it is determined that the value of the counter n is “4” or more (ACT 14, NO). Here, the control unit 60 performs error notification, such as displaying an error message on the display unit 204, in ACT 17. Here, the rotation of the paper tube 30 around the fixed shaft 41 of the delivery shaft 10 is stopped. As such, the control unit 60 ends the rotation of the paper tube 30 when data reading from the IC tag 32 is not successful even after repeating rotation by a certain angle such as 90 degrees until the paper tube 30 rotates one full circle. Then, the IC tag reading process shown in the flowchart is ended.

As described above, in the label printer 100 according to the first embodiment, the control unit 60 controls the ink ribbon delivery motor 65, the ink ribbon take-up motor 66, the delivery shaft intermediate sleeve 4201, and the take-up shaft intermediate sleeve 4202 which are drive units such that the paper tube 30 equipped with the IC tag 32 rotates around the fixed shaft 41 of the delivery shaft 10 by a predetermined angle. Therefore, in the first embodiment, when data from the IC tag 32 cannot be read depending on the position of the IC tag 32 adhered to the paper tube 30, the data of the IC tag 32 can be reliably read by rotating the paper tube 30 and reading the data. Therefore, it is possible to provide a printing device capable of good data communication with a ribbon roll.

The control unit 60 repeats the rotation of the paper tube 30 by a predetermined angle a plurality of times. As such, by performing rotation by a predetermined angle a plurality of times, the data of the IC tag 32 can be reliably read.

The label printer 100 includes the reader/writer 63 that performs data communication with the IC tag 32 via the antenna 40, and the control unit 60 controls the ink ribbon delivery motor 65, the ink ribbon take-up motor 66, the delivery shaft intermediate sleeve 4201 and the take-up shaft intermediate sleeve 4202 which are drive units such that the paper tube 30 equipped with the IC tag 32 rotates around the fixed shaft 41 of the delivery shaft 10 by a predetermined angle until the reader/writer 63 acquires the data recorded on the IC tag 32. Therefore, in the first embodiment, when data from the IC tag 32 cannot be read depending on the position of the IC tag 32 adhered to the paper tube 30, the data of the IC tag 32 can be reliably read by rotating the paper tube 30 and reading the data. Therefore, it is possible to provide a printing device capable of good data communication with a ribbon roll. The control unit 60 controls the reader/writer 63 to perform data communication with the IC tag 32 while the rotation of the paper tube 30 is stopped. Therefore, since data reading is performed while the IC tag 32 is not moving, the reader/writer 63 can reliably read the data of the IC tag 32. In other words, it is possible to prevent a situation in which data cannot be read because the IC tag 32 moves even though the IC tag 32 has reached a position where data can be read due to the rotation of the paper tube 30.

Note that since the predetermined angle is a fixed angle, such as 90 degrees, in repetition, control is easy. Note that 90 degrees is an example. The predetermined angle can be determined based on the radial sizes of the paper tube 30 and the antenna 40, and the assumed radial size of the IC tag 32. In other words, when the radial sizes of the paper tube 30, the antenna 40, and the assumed IC tag 32 are determined, the predetermined angle can be determined.

In the label printer 100 according to the first embodiment, when the control unit 60 acquires the data recorded on the IC tag 32 by the reader/writer 63, the control unit 60 causes the paper tube 30 to rotate in the opposite direction by the amount that the paper tube 30 has been rotated until then. Therefore, wasteful consumption of the ink ribbon can be prevented.

When the data recorded on the IC tag 32 cannot be acquired by the reader/writer 63 even after the paper tube 30 is rotated by a predetermined angle repeatedly until the paper tube 30 is rotated by a specified angle, which is 360 degrees that is one full circle here, the control unit 60 ends the rotation of the paper tube 30. Therefore, unnecessary feeding of the ink ribbon is prevented, and further consumption of the ink ribbon and waste of power can be prevented.

Although it has been explained that the process shown in FIG. 11 is started when the power switch 206 is turned on, the timing of the start is not particularly limited. For example, the process may be started by operating the display unit 204 or the operation unit 202. Alternatively, the start of the process may be controlled from the external device ED such as a host computer that controls the label printer 100 via the communication unit 67.

### Second Embodiment

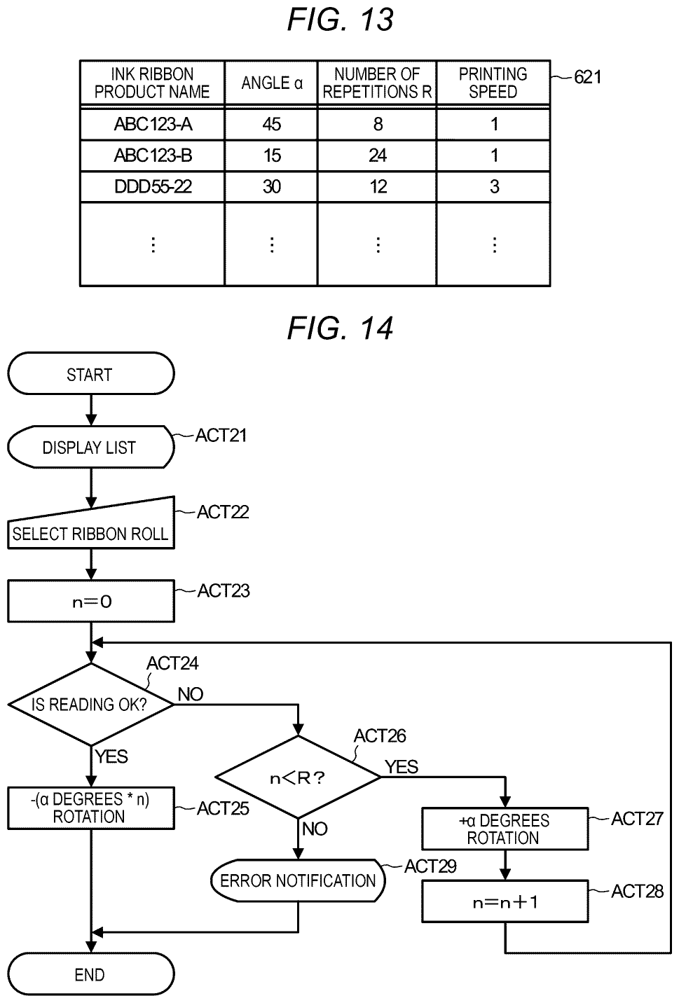

A label printer 100 according to a second embodiment will be described with reference to FIGS. 13 and 14. In the first embodiment, the paper tube 30 is rotated at a fixed angle of 90 degrees within the range of one full circle until data reading is OK, regardless of the type of attached ribbon roll RR, in other words, regardless of the shape and size of the IC tag 32 adhered to the paper tube 30 of the ribbon roll RR. In contrast, in the present embodiment, the fixed angle of rotation is changed depending on the IC tag 32 from which data is to be read.

FIG. 13 is a diagram showing an example of memory contents in a ribbon information memory 621 configured in the memory 62 of the label printer 100 according to the second embodiment. As described in the first embodiment, the ribbon information memory 621 stores data (printing speed) regarding the printing speed that matches the type of ink ribbon (ink ribbon product name). There are, for example, six levels of printing speed, and the number of level is stored in the ribbon information memory 621. The six levels of printing speeds are, for example, 76.2 mm/sec, 127 mm/sec, 203.2 mm/sec, 254 mm/sec, 304.8 mm/sec, and 355.6 mm/sec.

The ribbon information memory 621 stores a fixed angle α suitable for the type of ink ribbon, that is, the type of IC tag 32, and number of repetitions R for determining one full circle. Since it is easy to calculate the number of repetitions R based on the angle α, the number of repetitions R does not necessarily need to be stored in the ribbon information memory 621.

FIG. 14 is a flowchart showing an example of an IC tag reading process by the control unit 60 of the label printer 100 according to the second embodiment. The control unit 60 starts the process shown in FIG. 14, for example, when the power switch 206 is turned on.

In ACT 21, the control unit 60 generates a list of usable ribbon rolls RR based on the ink ribbon product names stored in the ribbon information memory 621, and displays the list as a selection list for allowing the user to select the type of ribbon roll RR to be used, on the display unit 204. Note that the selection list data may be stored in the memory 62 in addition to the ribbon information memory 621, and the control unit 60 may read and display the selection list data on the display unit 204.

In ACT 22, the control unit 60 accepts the selection of the ribbon roll RR by the user's operation of the operation unit 202.

In ACT 23, the control unit 60 initializes the value of the counter n to “0”. The processing operation is similar to ACT 11 of the first embodiment.

In ACT 24, the control unit 60 determines whether data reading is OK. The processing operation is similar to ACT 12 of the first embodiment.

In response to the determination that data reading is OK (ACT 24, YES), the control unit 60 rotates the paper tube 30 of the ribbon roll RR by −(α degrees×n) in ACT 25. That is, the delivery shaft intermediate sleeve 4201 and the take-up shaft intermediate sleeve 4202 are reversely rotated by an angle obtained by multiplying α degrees by the value of the counter n. That is, the paper tube 30 of the ink ribbon is reversely rotated by (n×α degrees). Here, since the value of the counter n is “0”, the IC tag reading process shown in the flowchart is ended without rotation.

In response to the determination that the data reading is not OK (ACT 24, NO), the control unit 60 reads the number of repetitions R of the ribbon roll RR selected in the processing operation of ACT 22 from the ribbon information memory 621 in ACT 26, and determines whether the value of the counter n is less than the number of repetitions R. That is, the number of repetitions required for the paper tube 30 to rotate one full circle is a fixed number of “4” in the first embodiment, whereas in the present embodiment, the number of repetitions is the number depending on the type of ribbon roll RR.

In response to the determination that the value of the counter n is less than the number of repetitions R (ACT 26, YES), in ACT 27, the control unit 60 reads the fixed angle α for the ribbon roll RR selected in the processing operation of ACT 22 from the ribbon information memory 621, and rotates the paper tube 30 of the ink ribbon forward by a degree. That is, while the fixed angle at which the paper tube 30 is rotated is a fixed angle of “90 degrees” in the first embodiment, in the present embodiment, the fixed angle is the rotation angle according to the type of ribbon roll RR.

In ACT 28, the control unit 60 increments the value of the counter n by “+1”. The processing operation is similar to ACT 16 of the first embodiment. Thereafter, the control unit 60 proceeds to the processing operation of ACT 24.

As such, the paper tube 30 is rotated by α degrees at a time until data reading is OK. As a result, when the data reading is OK (ACT 24, YES), the control unit 60 reversely rotates the paper tube 30 by (n×α degrees) in ACT 25. As a result, the ink ribbon that has been fed out to read data from the IC tag 32 is rewound onto the ribbon roll RR.

When the paper tube 30 rotates one full circle without data reading being OK, it is determined that the value of the counter n is greater than or equal to the number of repetitions R (ACT 26, NO). Here, the control unit 60 performs error notification, such as displaying an error message on the display unit 204, in ACT 29. The processing operation is similar to ACT 17 of the first embodiment. Then, the IC tag reading process shown in the flowchart is ended.

As described above, the label printer 100 according to the second embodiment also provides the same effects as the first embodiment.

In the label printer 100 according to the second embodiment, the control unit 60 switches a predetermined angle that is a fixed angle in repetition of the paper tube 30, depending on the type of ribbon roll RR. Therefore, since the paper tube 30 can be rotated at an appropriate angle, the data of the IC tag 32 can be read more reliably. The time required to read data can be shortened.

### Third Embodiment

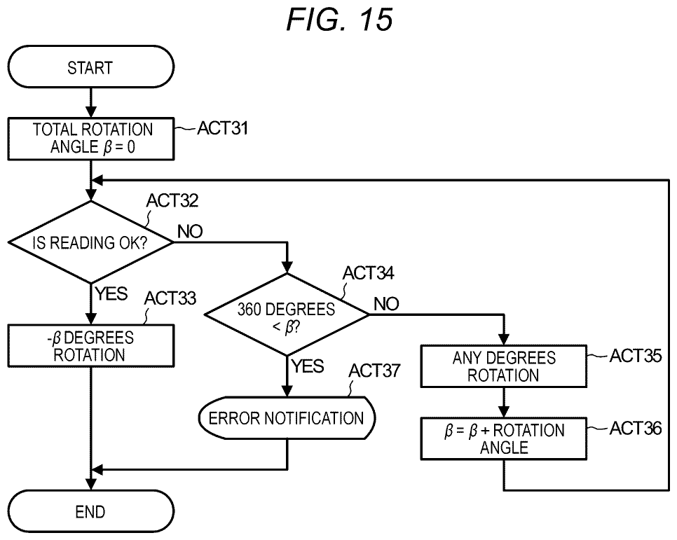

Hereinafter, a label printer 100 according to a third embodiment will be described with reference to FIG. 15. In the first embodiment, the paper tube 30 is rotated by a fixed angle of 90 degrees within the range of one full circle until data reading is OK. In contrast, in the present embodiment, the paper tube 30 is rotated while freely changing a rotation angle within the range of one full circle until data reading is OK.

FIG. 15 is a flowchart showing an example of the IC tag reading process by the control unit 60 of the label printer 100 according to the third embodiment. The control unit 60 starts the process shown in FIG. 15, for example, when the power switch 206 is turned on.

In ACT 31, the control unit 60 initializes a total rotation angle β stored in a temporary storage unit provided in the memory 62 to “0”, for example.

In ACT 32, the control unit 60 determines whether data reading is OK. The processing operation is similar to ACT 12 of the first embodiment.

In response to the determination that data reading is OK (ACT 32, YES), the control unit 60 rotates the paper tube 30 of the ribbon roll RR by −β degrees in ACT 33. That is, the delivery shaft intermediate sleeve 4201 and the take-up shaft intermediate sleeve 4202 are reversely rotated by the total rotation angle β. That is, the paper tube 30 of the ink ribbon is reversely rotated by β degrees. Here, since the total rotation angle β is “0 degree”, the IC tag reading process shown in the flowchart is ended without rotation.

In response to the determination that data reading is not OK (ACT 32, NO), the control unit 60 determines in ACT 34 whether the total rotation angle β is less than 360 degrees. That is, in the first embodiment, it is determined whether the paper tube 30 has rotated one full circle based on the number of repetitions, whereas in the present embodiment, the same is determined based on the actual rotated angle.

In response to the determination that the total rotation angle β is less than 360 degrees (ACT 34, YES), the control unit 60 rotates the paper tube 30 of the ink ribbon forward by a freely selected angle in ACT 35. That is, while the fixed angle at which the paper tube 30 is rotated is a fixed angle of “90 degrees” in the first embodiment, in the present embodiment, the fixed angle is a freely selected angle. Note that the freely selected angle may be any number other than 0 degrees, but when the angle is too small, there will be no change in the reading, so it is desirable that the freely selected angle is greater than a certain degree, such as 15 degrees, for example. The freely selected angle in repetition does not need to be the same angle each time.

In ACT 36, the control unit 60 updates the total rotation angle β by adding a rotation angle, which is the freely selected angle rotated in the processing operation of ACT 35, to the total rotation angle β stored in the memory 62. Thereafter, the control unit 60 proceeds to the processing operation of ACT 32.

As such, the paper tube 30 is rotated by the freely selected angle until data reading is OK. As a result, when the data reading is OK (ACT 32, YES), the control unit 60 reversely rotates the paper tube 30 by a total rotation angle of β degrees in ACT 33. As a result, the ink ribbon that has been fed out to read data from the IC tag 32 is rewound onto the ribbon roll RR.

When the paper tube 30 rotates one full circle without data reading being OK, it is determined that the total rotation angle β is 360 degrees or more (ACT 34, NO). Here, the control unit 60 performs error notification, such as displaying an error message on the display unit 204, in ACT 37. The processing operation is similar to ACT 17 of the first embodiment. Then, the IC tag reading process shown in the flowchart is ended.

As described above, in the label printer 100 according to the third embodiment, the predetermined angle for each repeated rotation of the paper tube 30 can be an angle that is not fixed, and even then, the same effect as in the first embodiment can be obtained.

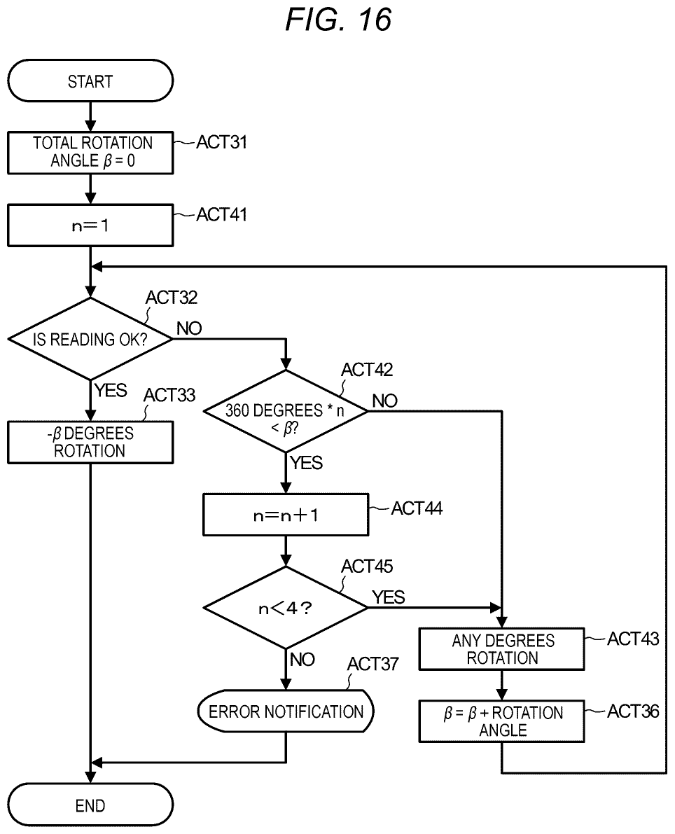

Note that the freely selected angle may be 360 degrees or more. Here, the IC tag reading process is as shown in FIG. 16. FIG. 16 is a flowchart showing an example of an IC tag reading process by the control unit 60 of a label printer 100 according to a modification example of the third embodiment. Processing operations that are the same as those shown in FIG. 15 are denoted by the same reference numerals, and the explanation will be omitted, and in the following, only the parts that are different from the processing operations shown in FIG. 15 will be explained.

After initializing the total rotation angle β to “0” in ACT 31, the control unit 60 initializes the value of the counter n to “0” in ACT 41. Thereafter, the control unit 60 proceeds to the process of ACT 32.

In response to the determination that data reading is not OK (ACT 33, NO), the control unit 60 reads the total rotation angle β and the value of the counter n stored in the memory 62 in ACT 42, and determines whether the total rotation angle β is less than 360 degrees×n. For example, when the value of the counter n is “1”, it is determined whether the total rotation angle β is less than 360 degrees, that is, whether the paper tube 30 has rotated one full circle by repeating the rotation by freely selected angle. When the freely selected angle is less than 360 degrees, the determination is NO, and when the freely selected angle is 360 degrees or more, the determination is YES.

In response to the determination that the total rotation angle β is less than 360 degrees×n (ACT 42, YES), the control unit 60 rotates the paper tube 30 of the ink ribbon forward by a freely selected angle in ACT 43. Here, the freely selected angle may be 360 degrees or more. Thereafter, the control unit 60 proceeds to the processing operation of ACT 36.

As such, the paper tube 30 is rotated by a freely selected angle until data reading is OK. When data reading is not OK (ACT 32, NO) and the paper tube 30 is rotated by n×360 degrees or more, it is determined in ACT 42 that the total rotation angle β is 360 degrees×n or more (ACT 42, YES). In response to the determination, in ACT 44, the control unit 60 increments the value of the counter n by “+1”.

In ACT 45, the control unit 60 determines whether the value of the counter n is less than “4”. The value “4” is an example. Here, it is assumed that it is determined whether the paper tube 30 has already rotated three full circles. In response to the determination that the value of the counter n is less than “4” (ACT 45, YES), the control unit 60 proceeds to the processing operation of ACT 43 above.

As such, data reading is attempted by rotating the paper tube 30 forward by a freely selected angle until the paper tube 30 performs one full circle a specified number of times, three times here. When data reading fails even after the paper tube 30 repeats one full circle a specified number of times, it is determined that the value of the counter n is “4” or more (ACT 45, NO), and the control unit 60 proceeds to the processing operation of the above-described ACT 37.

In the embodiment described above, the IC tag reading process is ended after the error notification is performed, but the ink ribbon that has been fed out to read data from the IC tag 32 may be rewound, and then the IC tag reading process may be ended after an error notification.

Alternatively, after reporting the error, the display unit 204 displays a confirmation message to the user to confirm whether to print at the specified printing speed, and upon approval from the operation unit 202, the specified printing speed may be adopted and the ribbon roll RR from which data could not be read may be used.

In the embodiment, to reduce wasteful consumption of the ink ribbon, when the data of the IC tag 32 is read, the ink ribbon that has been fed out to read the data is rewound. However, it is also possible to simply end the feeding out of the ink ribbon when the data of the IC tag 32 is read without performing rewinding. As a result, the ink ribbon is not fed out any further, so wasteful consumption of the ink ribbon can be reduced, although it is less than in the case of rewinding. Since the ink ribbon is not rewound, there is an advantage that it is possible to shift to the printing operation immediately. There is no need for operations such as taking up the slack in the ink ribbon, by reversely rotating the ink ribbon delivery motor 65 and rotating the ink ribbon take-up motor 66 forward by minute angles, after rewinding.

An antenna and an IC tag may be attached to the supply shaft 6 and the core material of the label paper roll, similarly to the delivery shaft 10 and the paper tube 30. Here, the label paper roll is an example of the paper roll described in the claims of the present application, and the core material is an example of the cylindrical body described in the claims of the present application. By attaching the antenna to the supply shaft 6 and attaching the IC tag to the label paper roll as such, the control unit 60 of the label printer 100 can acquire various types of data such as paper size, thickness, and material.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printing device comprising:
a shaft inserted in a cylindrical body of a medium roll in which a medium is wound around the cylindrical body that has a wireless tag, and rotatably supporting the cylindrical body;
an antenna provided on the shaft configured to perform data communication with the wireless tag;
a driver configured to rotate the cylindrical body having the wireless tag around the shaft; and
a controller configured to control the driver such that the cylindrical body having the wireless tag rotates around the shaft by a predetermined angle.

2. The device according to claim 1, wherein
the controller is configured to control the driver to repeat the rotation of the cylindrical body by the predetermined angle a plurality of times.

3. The device according to claim 2, further comprising:
a data communicator configured to perform data communication with the wireless tag via the antenna, wherein
the controller configured to:
control the data communicator to perform the data communication with the wireless tag while the cylindrical body is not rotating, and
control, when data recorded on the wireless tag is acquired by the data communicator, the driver configured to rotate the cylindrical body in an opposite direction by an amount by which the cylindrical body is rotated until then.

4. The device according to claim 1, further comprising:
a printer configured to perform printing on printing paper via an ink ribbon, wherein
the medium roll is a ribbon roll in which the ink ribbon is wound around the cylindrical body.

5. The device according to claim 1, further comprising:
a printer configured to perform printing on printing paper via an ink ribbon, wherein
the medium roll is a paper roll in which a long strip of printing paper is wound around the cylindrical body.

6. A control method for a printer, the printer including a shaft inserted in a cylindrical body of a medium roll in which a medium is wound around the cylindrical body that has a wireless tag, and rotatably supporting the cylindrical body, an antenna provided on the shaft to perform data communication having the wireless tag, and a driver configured to rotate the cylindrical body equipped with the wireless tag around the shaft, the method comprising:
controlling the driver such that the cylindrical body having the wireless tag rotates around the shaft by a predetermined angle.

7. The device according to claim 1, wherein the antenna includes a loop antenna.

8. The device according to claim 1, wherein the antenna includes a continuous metal foil.

9. The device according to claim 1, wherein the predetermined angle is 90°.

10. The device according to claim 4, wherein the ink ribbon overlaps an outside of the wireless tag.

11. The device according to claim 5, wherein the ink ribbon overlaps an outside of the wireless tag.

12. The device according to claim 4, wherein the printer includes a thermal head.

13. The device according to claim 12, further comprising a platen roller facing the thermal head, with the ink ribbon disposed between the platen roller and the thermal head.

14. The device according to claim 5, wherein the printer includes a thermal head.

15. The device according to claim 14, further comprising a platen roller facing the thermal head, with the ink ribbon disposed between the platen roller and the thermal head.
